(19) United States
(12) Patent Application Publication
(10) Pub. No.: US 2026/0091608 A1
(43) Pub. Date: Apr. 2, 2026

(54) TAPE CASSETTE INCLUDING INK RIBBON, TAPE, AND HOUSING INCLUDING FIRST PARTITION PLATE AND ARM

(71) Applicant: BROTHER KOGYO KABUSHIKI KAISHA, Nagoya (JP)

(72) Inventor: Shinji UKAI, Kiyosu (JP)

(21) Appl. No.: 19/333,597

(22) Filed: Sep. 19, 2025

(30) Foreign Application Priority Data
Sep. 30, 2024 (JP) 2024-171834

(51) Int. Cl. B41J 33/22; B41J 2/325; B41J 3/36; B41J 3/407; B41J 11/04; B41J 15/04; B41J 33/00

(52) U.S. Cl. CPC B41J 33/22; B41J 2/325; B41J 3/36; B41J 3/4075; B41J 11/04; B41J 15/044; B41J 15/046; B41J 15/048; B41J 33/003

(57) ABSTRACT

A tape cassette includes: a ribbon roll in which an ink ribbon is wound; a tape roll in which a tape is wound; and a housing having an opening space. The housing includes a first partition plate and an arm. The arm has a discharge port allowing the ink ribbon and the tape to be discharged to the opening space through the discharge port. In the tape cassette, the ink ribbon has a leading part extending from an interior of the arm to an outside of the housing through both the discharge port and the opening space. The leading part has a leading edge positioned outside the housing.

### REFERENCE TO RELATED APPLICATIONS

This application claims priority from Japanese Patent Application No. 2024-171834 filed on Sep. 30, 2024. The entire content of the priority application is incorporated herein by reference.

### BACKGROUND ART

A known tape cassette includes a housing accommodating therein a first roll, a second roll, and an input spool. In the first roll, a tape is wound. In the second roll, an ink ribbon is wound. The input spool takes up a used ink ribbon for collecting the used ink ribbon.

### SUMMARY

There is a demand for a tape cassette enabling the leading edge of a used ink ribbon to be positioned outside the tape cassette. However, in the known tape cassette, since the input spool takes up the used ink ribbon, the leading edge of the used ink ribbon is positioned inside a housing of the tape cassette.

In view of the foregoing, it is an object of the present disclosure to provide a tape cassette enabling the leading edge of a used ink ribbon to be positioned outside a housing of the tape cassette.

In order to attain the above and other objects, the present disclosure provides a tape cassette including: a ribbon roll in which an ink ribbon is wound; a tape roll in which a tape is wound; and a housing. The ribbon roll is rotatable about a first rotational axis extending in a first direction. The tape roll is rotatable about a second rotational axis extending in the first direction. The housing has an opening space in which the tape and the ink ribbon overlap each other for printing. The housing includes a first partition plate and an arm. The first partition plate partitions an internal space of the housing into a first space in which the ribbon roll is positioned and a second space in which the tape roll is positioned. The first space and the second space are arranged in the first direction. The arm is positioned on an opposite side of the first partition plate from the second space in the first direction. The arm has a discharge port allowing the ink ribbon and the tape to be discharged to the opening space through the discharge port. In the tape cassette, the ink ribbon has a leading part extending from an interior of the arm to an outside of the housing through both the discharge port and the opening space. The leading part has a leading edge positioned outside the housing.

In the above structure, the ink ribbon discharged from the discharge port is used for printing. The leading edge of the ink ribbon discharged from the discharge port is positioned at the outside of the housing. That is, the ink ribbon has the leading part extending from the interior of the arm to the outside of the housing through the discharge port and the head opening space, and the leading part of the ink ribbon has the leading edge positioned outside the housing. Hence, the used ink ribbon does not remain in the inside of the housing. With the structure of the tape cassette, the leading edge of the used ink ribbon can be positioned in the outside of the housing.

### BRIEF DESCRIPTION OF DRAWINGS

FIG. 1 is a perspective view of a printer 1.

FIG. 2 is a perspective view of the printer 1, with a cover 3 removed.

FIG. 3 is a perspective view of a printing unit 50.

FIG. 4 is a front view of a drive shaft 63.

FIG. 5 is an exploded perspective view of a tape cassette 100.

FIG. 6 is a perspective view of a fourth space S4.

FIG. 7 is another perspective view of the fourth space S4.

FIG. 8 is a view of the tape cassette 100 from the other side in a first direction.

FIG. 9 is a view of a third space S3 from the other side in the first direction.

FIG. 10 is a view of a second space S2 from one side in the first direction.

FIG. 11 is a cross-sectional view of the tape cassette 100 taken along line XI-XI in FIG. 8.

FIG. 12 is a view of a third space S3 of a tape cassette 100A from the other side in the first direction.

### DESCRIPTION

A printer 1 and a tape cassette 100 according to an embodiment of the present disclosure will be described while referring to the accompanying drawings. The drawings are used to describe the technical features made possible with the present disclosure. In other words, the configurations illustrated in the drawings are merely examples, and are not intended to limit the scope of the present disclosure only to the configurations. That is, the configurations may be modified as appropriate without departing from the spirit and scope of the disclosure.

Further, for each component in the printer 1, the center of the component in the left-right direction will be simply referred to as the “left-right center of the component”. The same applies to the up-down direction and the front-rear direction.

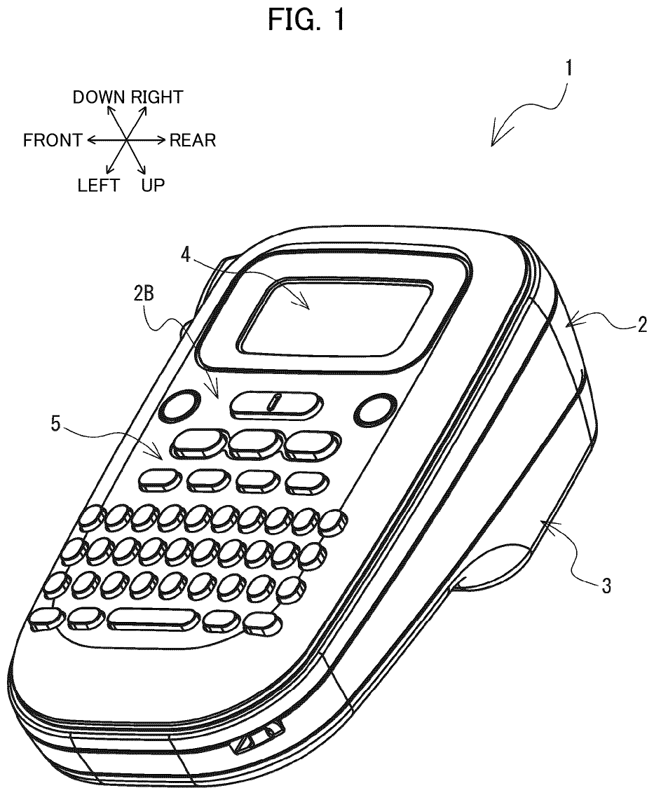

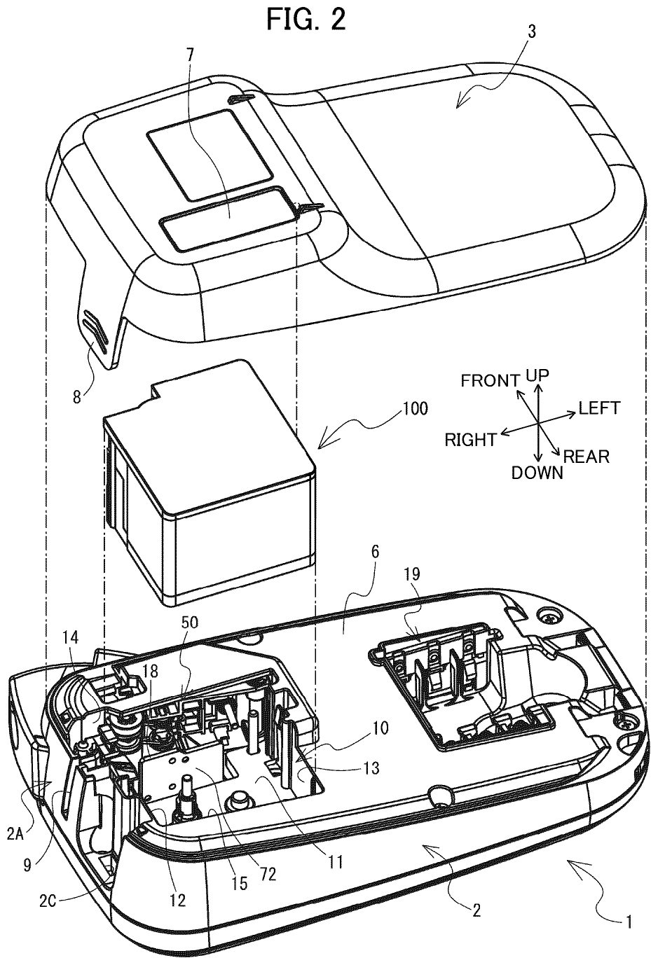

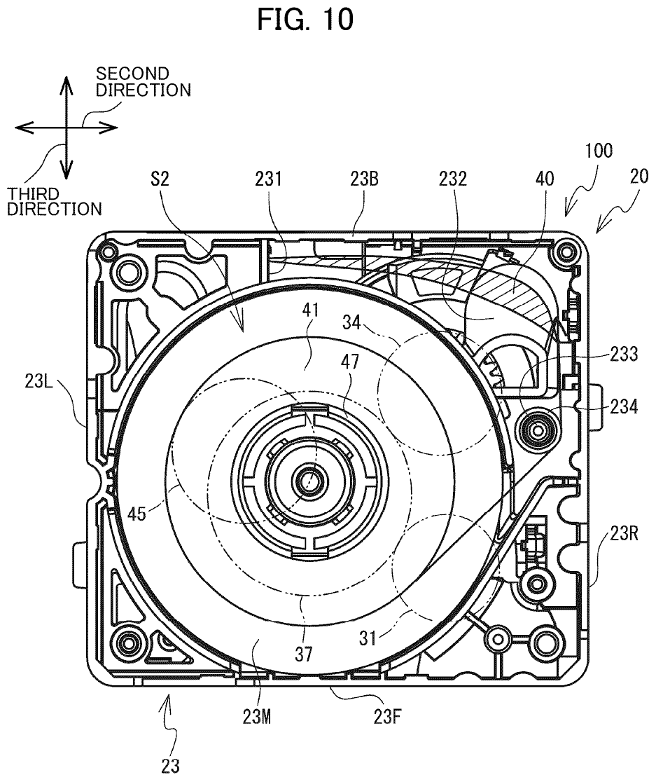

Here, the configuration of the printer 1 will be described. As illustrated in FIGS. 1 and 2, the printer 1 is a portable label printer. The printer I can create labels by printing images on a tape 40 illustrated in FIG. 10. The printer 1 can print images, such as text and graphics, on the tape 40.

As illustrated in FIGS. 1 and 2, the printer 1 includes a housing 2, a cover 3, a display unit 4, and an input unit 5.

The housing 2 has a box-like shape that is elongated in the left-right direction. The upper part of the housing 2 opens. Since an inner cover 6 is mounted on the opening, the interior of the housing 2 is protected. A right wall 2A of the housing 2 has a discharge passage 9, and an engagement hole 2C. The discharge passage 9 extends through the right wall 2A in the left-right direction. The engagement hole 2C is configured to engage with an opening/closing part 8 of the cover 3.

The cover 3 is removably mounted on the housing 2. The cover 3 extends in the left-right direction. The cover 3 has a shape recessed upward. Specifically, the part of the cover 3 facing the housing 2 is recessed upward in a state where the cover 3 is mounted on the housing 2. In a state where the cover 3 is mounted on the housing 2, the cover 3 covers the entire top part of the housing 2 (i.e., the cover 3 covers the opening formed at the top part of the housing 2 and the inner cover 6).

The cover 3 includes a window 7 at the right part of the cover 3. The window 7 is at a position corresponding to the rear end part of a cassette accommodation section 10. For example, a user can see a label affixed to the top surface of the tape cassette 100 through the window 7. The label indicates the type of the tape 40, for example.

The display unit 4 is a liquid crystal display, for example. The display unit 4 can display various information. The display unit 4 is disposed on the right end part of a bottom surface 2B of the housing 2.

Through the input unit 5, a user can input various information. The input unit 5 is disposed on the left part of the bottom surface 2B of the housing 2. In other words, the input unit 5 is disposed further leftward than the display unit 4. The input unit 5 includes various keys. For example, the various keys are Character keys, a Print button, and an Esc key.

As illustrated in FIG. 2, the printer 1 includes the cassette accommodation section 10, a battery accommodation section 19, and a printing unit 50 in the housing 2.

The cassette accommodation section 10 is configured to accommodate the tape cassette 100. In other words, the tape cassette 100 is detachably attachable to the cassette accommodation section 10. The cassette accommodation section 10 is positioned further rightward than the left-right center of the inner cover 6. The cassette accommodation section 10 is recessed downward. The cassette accommodation section 10 has a recess bottom surface 11, and recess peripheral surfaces 12 through 15. The recess peripheral surfaces 12 through 15 are connected to the recess bottom surface 11 and surround the same in the front-rear and left-right directions.

The battery accommodation section 19 is configured to accommodate a battery (not illustrated). In the housing 2, the battery accommodation section 19 is recessed downward and is positioned further leftward than the left-right center of the housing 2.

In a state where the cover 3 is removed from the housing 2, the cassette accommodation section 10 and the battery accommodation section 19 are exposed to the outside of the printer 1. That is, in a state where the cover 3 is removed from the housing 2, the cassette accommodation section 10 and the battery accommodation section 19 are visible from the outside of the printer 1. Therefore, in a state where the cover 3 is removed from the housing 2, a user can replace the tape cassette 100 and the battery.

The printing unit 50 is a printing unit for printing an image onto the tape 40. The printing unit 50 is disposed in the front-rear center of the housing 2 and in the bottom part of the cassette accommodation section 10.

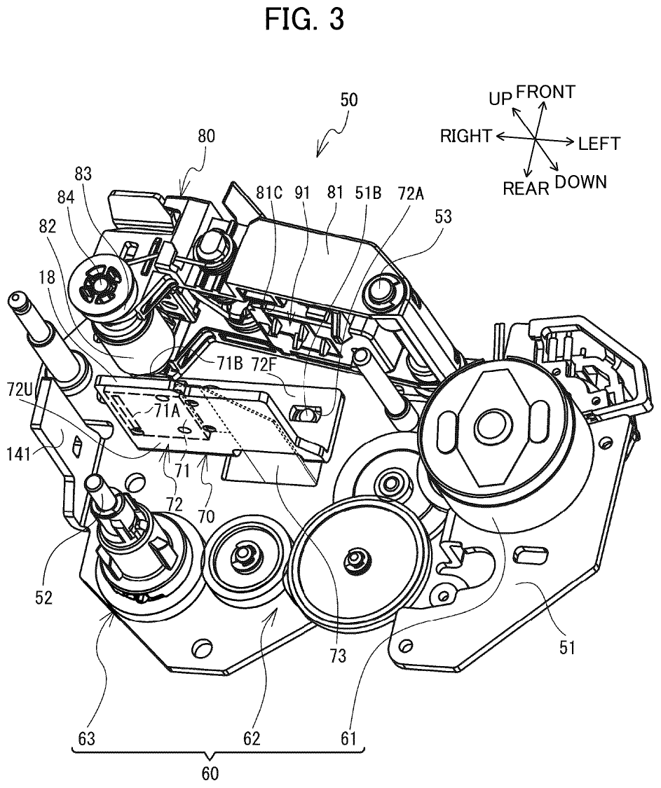

As illustrated in FIG. 3, the printing unit 50 includes a base 51, a head unit 70, a platen unit 80, and a drive mechanism 60, for example.

As illustrated in FIG. 3, the base 51 supports components of the printing unit 50. The base 51 is a metal plate, for example. The base 51 has plate surfaces facing opposite directions in the up-down direction. The length of the base 51 in the left-right direction is greater than the length of the base 51 in the front-rear direction. An attachment part 141, a pin 51B, and a shaft 52 are provided at the base 51, for example.

The attachment part 141 is disposed on the right edge of the base 51 and on the front-rear center of the base 51. The attachment part 141 extends upward. The attachment part 141 has plate surfaces facing opposite directions in the left-right direction. The attachment part 141 is a metal plate, for example.

The pin 51B is disposed in the left-right center and front-rear center of the base 51. The pin 51B extends upward from the base 51. The pin 51B has a columnar shape. Note that another pin identical to the pin 51B is disposed further rightward than the pin 51B. The other pin is not illustrated in the drawings. The shaft 52 is disposed on the right-rear part of the base 51. The shaft 52 extends upward.

As illustrated in FIG. 3, the head unit 70 is mounted on the base 51. The head unit 70 includes a heat sink 72, and a print head 71.

The heat sink 72 holds the print head 71. The heat sink 72 is a metal plate for dissipating heat from the print head 71. The heat sink 72 is disposed in the front-rear center of the right part of the base 51. The heat sink 72 includes a first plate 72F, and a second plate 72U.

The first plate 72F has plate surfaces facing opposite directions in the up-down direction. The length of the first plate 72F in the left-right direction is greater than the length of the first plate 72F in the front and rear direction. A hole 72A is formed in the first plate 72F. The hole 72A extends through the first plate 72F in the up-down direction.

The pin 51B is inserted into the hole 72A. In this state, the first plate 72F is fixed to the base 51 with screws 51C.

The second plate 72U extends upward from the rear edge of the first plate 72F. The second plate 72U has plate surfaces facing opposite directions in the front-rear direction. The length of the second plate 72U in the left-right direction is greater than the length of the second plate 72U in the up-down direction. The right-upper surface of the second plate 72U functions as a support part 18 for supporting the tape cassette 100 when the tape cassette 100 is attached to the printer 1.

The print head 71 is fixed to the front surface of the second plate 72U of the heat sink 72 with adhesive. The print head 71 is a rectangular circuit board on which a plurality of heating elements 71A, and a driver circuit 71B are mounted. The heating elements 71A are arranged in the up-down direction on the right end part of the print head 71. The driver circuit 71B is disposed on the front part of the print head 71. The driver circuit 71B is electrically connected to a control unit (not illustrated) of the printer 1 via a harness 73.

As illustrated in FIG. 3, the platen unit 80 is disposed on the front part of the base 51. The left end part of the platen unit 80 is pivotably supported by a rotational shaft 53. The rotational shaft 53 of the platen unit 80 is disposed on the left part of the front end of the base 51. The rotational shaft 53 extends upward. The platen unit 80 is pivotally movable about the rotational shaft 53, and thus the right end part of the platen unit 80 is movable in the front-rear direction.

A platen roller 82 is configured to slide between an adjacent position (not illustrated) and a separated position illustrated in FIG. 3. Specifically, the pivotal movement of the platen unit 80 causes the platen roller 82 to slide between the adjacent position and the separated position. At the adjacent position, the platen roller 82 is positioned near the print head 71. At the separated position, the platen roller 82 is separated from the print head 71.

In the following description related to components of the platen unit 80, directions of the components of the platen unit 80 will be described based on a state where the platen roller 82 is at the adjacent position. Also, the directions of the components of the platen unit 80 will be based on the directions of the components of the printer 1 described above (i.e., the up-down direction, left-right direction, and front-rear direction of the printer 1).

The platen unit 80 includes a platen holder 81, a platen shaft 84, the platen roller 82, a platen gear 83, and a detection part 91.

The left end part of the platen holder 81 opens rearward. The platen holder 81 includes a bottom wall and a top wall. The bottom wall has a support hole extending therethrough in the up-down direction. Also, the top wall has a support hole extending therethrough in the up-down direction. The rotational shaft 53 of the base 51 is inserted into the support holes. The platen roller 82 is rotatably supported between the right end part of the bottom wall and the right end part of top wall of the platen holder 81.

The platen shaft 84 is a shaft extending in the up-down direction. The platen roller 82 is cylindrical shape extending in the up-down direction. The platen shaft 84 is inserted into the platen roller 82. The platen shaft 84 is configured to rotate together with the platen roller 82.

The platen gear 83 is fixed to the top part of the platen shaft 84. The platen shaft 84 protrudes further upward than the top wall of the platen holder 81. The platen gear 83 is a helical gear. The gear teeth of the platen gear 83 are helical at a prescribed angle relative to the up-down direction. The platen shaft 84 is configured to rotate together with the platen gear 83.

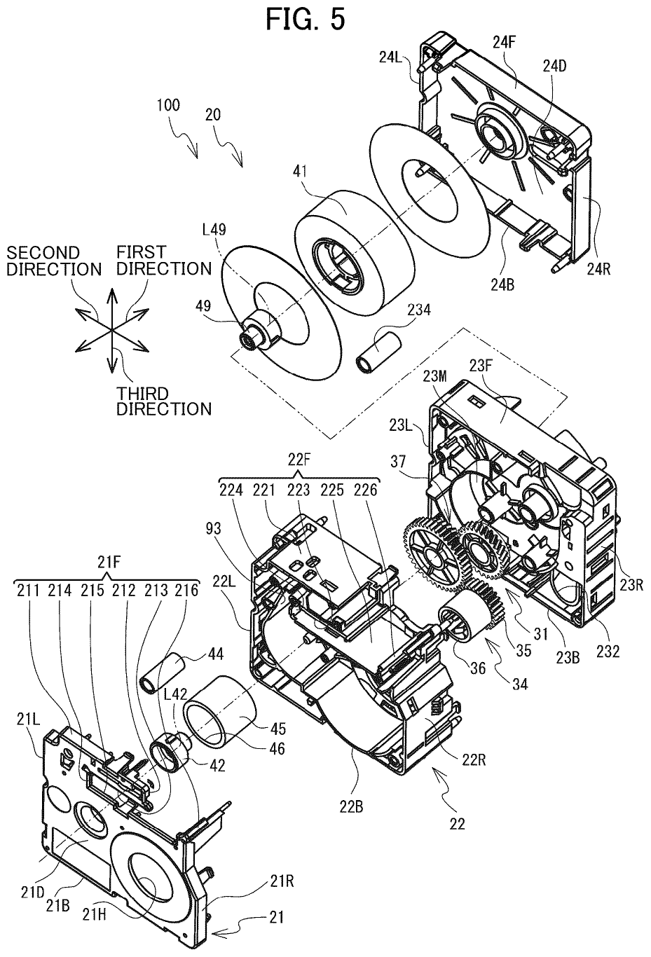

The platen roller 82 is configured to nip the tape 40 and an ink ribbon 43 together with the print head 71 when the platen roller 82 is at the adjacent position. The platen gear 83 is configured to mesh with a second gear 31 (see FIG. 5) of the tape cassette 100.

The drive force of a drive shaft 63 described later is configured to be inputted into the platen roller 82 via the tape cassette 100 and the platen gear 83. The tape 40, which is nipped between the platen roller 82 and the print head 71, is conveyed towards the discharge passage 9 by the rotation of the platen roller 82.

As illustrated in FIG. 3, the platen holder 81 has a holding section 81C positioned further rearward than the front-rear center of the platen holder 81. The holding section 81C is recessed forward. The holding section 81C holds the detection part 91.

The detection part 91 includes mechanical switches. The switches of the detection part 91 are turned on and off by a detection target part (not illustrated) of the tape cassette 100. The detection part 91 is configured to detect cassette identification information assigned to the tape cassette 100 based on the combination of on/off signals from the switches.

As illustrated in FIG. 3, the drive mechanism 60 is mounted on the base 51. The drive mechanism 60 includes a motor 61, a gear train 62, and the drive shaft 63. The motor 61, gear train 62, and base 51 are disposed inside the housing 2 and further downward than the inner cover 6.

The motor 61 is the drive source of a drive transmission mechanism 30 described later. The motor 61 is disposed on the left end part of the base 51. The gear train 62 including a plurality of gears coupled together is configured to transmit the drive force of the motor 61 to the drive shaft 63.

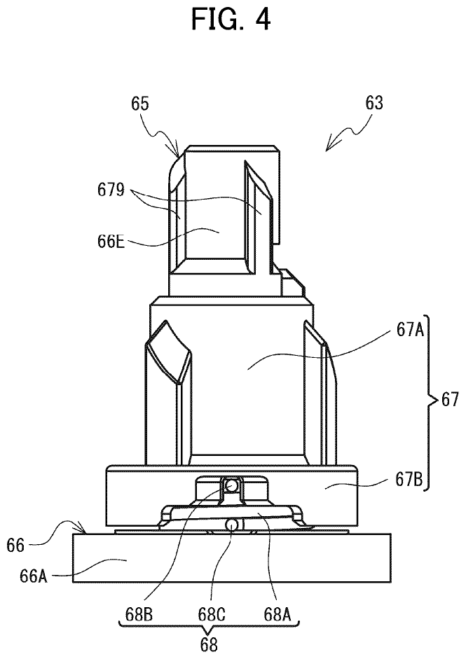

The drive shaft 63 will be described while referring to FIGS. 3 and 4. The drive shaft 63 is disposed on the right-rear corner part of the base 51. The shaft 52 disposed on the base 51 is inserted through the drive shaft 63. The drive shaft 63 is exposed in the cassette accommodation section 10. That is, the drive shaft 63 is visible from the outside of the printer 1 in a state where the cover 3 is removed from the housing 2.

The drive shaft 63 is configured to be inserted into a first gear 34 described later. A drive force of the motor 61 is inputted into the drive shaft 63 via the gear train 62. The drive shaft 63 rotates the first gear 34 when the drive shaft 63 receives a drive force from the motor 61.

The drive shaft 63 includes a drive gear 66, a clutch spring 68, and a drive cam 67.

The drive force of the motor 61 is transmitted to the drive gear 66 via the gear train 62. The drive gear 66 is made of a resin material, for example.

The drive gear 66 includes a gear 66A, and a shaft 65.

The gear 66A is in meshing engagement with the most downstream gear of the gear train 62 illustrated in FIG. 3. The gear 66A is rotated by receiving a drive force of the motor 61 illustrated in FIG. 3 via the gear train 62. The shaft 65 extends upward from the gear 66A.

The shaft 65 has a cylindrical shape. The shaft 65 has a diameter smaller than the diameter of the gear 66A. The shaft 52 is inserted through the shaft 65. The shaft 65 is configured to rotate together with the gear 66A around the shaft 52.

The top part of the shaft 65 is a shaft 66E. The shaft 66E has a cylindrical shape. A transmission gear 679 extending in the up-down direction is provided on the outer circumferential surface of the shaft 66E. The shaft 66E is configured to be inserted into the first gear 34 described later. The shaft 66E is configured to transmit a drive force of the motor 61 to the first gear 34 via the transmission gear 679.

The clutch spring 68 is a coil spring. The clutch spring 68 has a body 68A, a first arm 68B, and a second arm 68C.

The body 68A is mounted on the outer circumferential surface of a first shaft 66B of the drive gear 66. The body 68A extends in the up-down direction while forming a spiral shape. The first arm 68B extends outward in a radial direction of the shaft 65 from the top part of the body 68A. The second arm 68C extends outward in the radial direction of the shaft 65 from the bottom part of the body 68A.

The drive cam 67 is mounted on the shaft 65. The drive cam 67 has a cylindrical shape. The drive cam 67 is made of a resin material different from the resin material used for the drive gear 66, for example. In this case, the drive cam 67 is made of a different type or grade of resin material than the resin material used for the drive gear 66.

The drive cam 67 has a cam part 67A and a spring accommodation part 67B.

The cam part 67A has a cylindrical shape that extends in the up-down direction. The spring accommodation part 67B is provided on the bottom part of the cam part 67A. The spring accommodation part 67B has a cylindrical shape that extends in the up-down direction. The spring accommodation part 67B has a diameter larger than the diameter of the cam part 67A. The spring accommodation part 67B accommodates the clutch spring 68.

The shaft 65 is inserted into the drive cam 67. The shaft 66E is the part of the shaft 65 extending further upward than the drive cam 67.

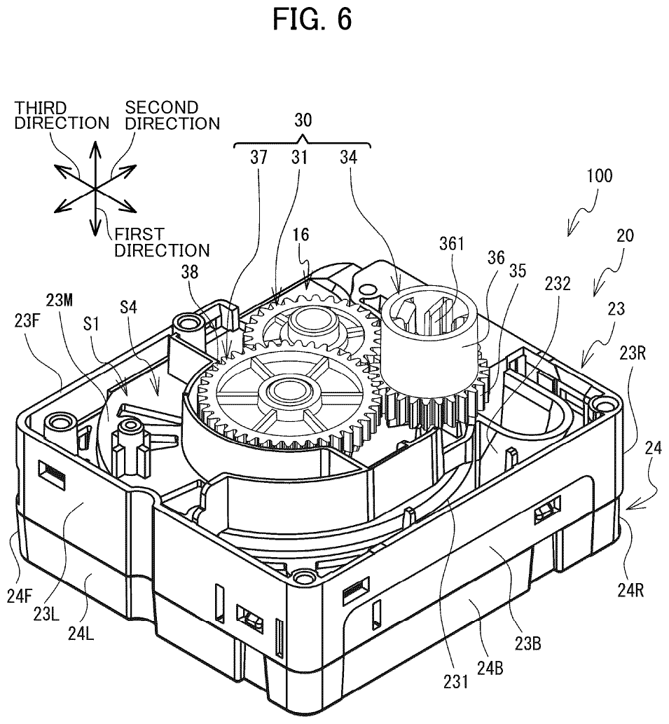

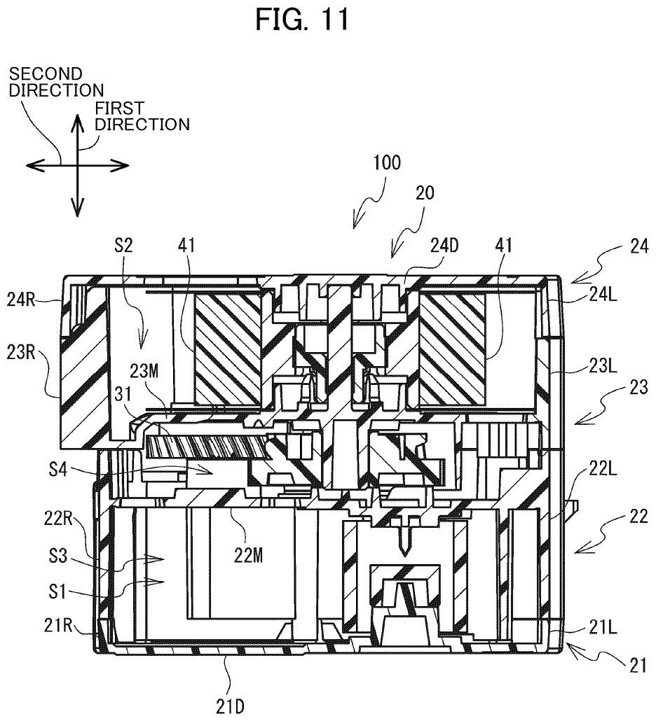

The tape cassette 100 will be described while referring to FIGS. 2 and 5 through 11. The tape cassette 100 is detachably attachable to the cassette accommodation section 10 illustrated in FIG. 2.

Further, for each component in the tape cassette 100, the center of the component in a first direction will be simply referred to as the “first direction center of the component”. The same applies to a second direction, and a third direction.

The tape cassette 100 includes a housing 20. The tape cassette 100 further includes a ribbon roll 45 and a tape roll 41. Tape cassettes 100 which are detachably attachable to the cassette accommodation section 10 of the printer I can be interchanged to replenish the tape 40 and to change the type of tape 40 (e.g., the size, color, material, etc.).

In the ribbon roll 45, the ink ribbon 43 is wound about a ribbon spool 46. The ribbon spool 46 is rotatable about a rotational axis L42 extending in the first direction. The rotational axis L42 will be described later. In a state where the ink ribbon 43 is wound about the ribbon spool 46, the ribbon spool 46 is rotatable about the rotational axis L42 extending in the first direction. Therefore, the ribbon roll 45 is rotatable about the rotational axis L42 extending in the first direction.

The ribbon spool 46 has a cylindrical shape extending in the first direction. The ink ribbon 43 has a strip-shape. The ink ribbon 43 is used for printing an image onto the tape 40. The ink ribbon 43 is overlaid on the tape 40 in a head opening space described later and is used for printing by the print head 71.

In the tape roll 41, the tape 40 is wound about a tape spool 47. The tape spool 47 is rotatable about a rotational axis L49 extending in the first direction. The rotational axis L49 will be described later. In a state where the tape 40 is wound about the tape spool 47, the tape spool 47 is rotatable about the rotational axis L49 extending in the first direction. Therefore, the tape roll 41 is rotatable about the rotational axis L49 extending in the first direction.

The tape spool 47 has a cylindrical shape extending in the first direction. The tape 40 has a strip shape. The tape 40 has a structure in which release paper is pasted on one surface of the tape 40 which adhesive is coated for covering the one surface of the tape 40, for example. Images can be printed onto the tape 40 by the print head 71.

The tape roll 41 and the ribbon roll 45 are positioned in the housing 20 at one side part of the housing 20 in the second direction. In other words, the tape spool 47 and the ribbon spool 46 are positioned in the housing 20 at the one side part of the housing 20 in the second direction.

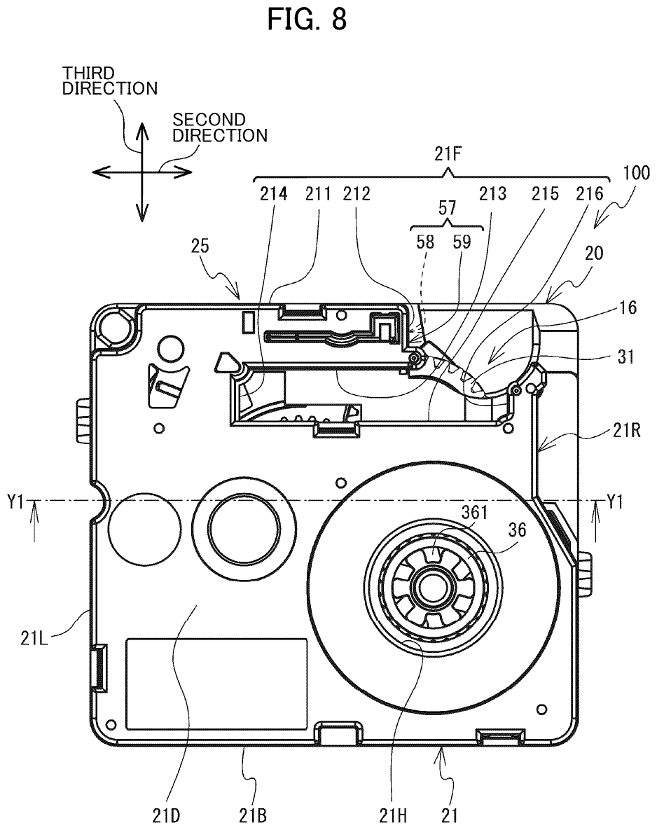

As illustrated in FIG. 2, the outer shape of the tape cassette 100 is a rectangular parallelepiped shape. As illustrated in FIG. 8, the tape cassette 100 includes the housing 20. The housing 20 includes an arm 25. The arm 25 is positioned at one end part of the housing 20 in the third direction. In other words, the arm 25 is positioned closer to the one end part of the housing 20 in the third direction than to the other end part of the housing 20 in the third direction. The arm 25 has a discharge port 57. The tape 40 and the ink ribbon 43 can be discharged to the outside of the housing 20 through the discharge port 57. The arm 25 will be described later.

The housing 20 includes a case 21, a case 22, a case 23, and a case 24.

The housing 20 has one end part and the other end part in the first direction. As illustrated in FIG. 5, the case 21 forms the other end part of the housing 20 in the first direction. The case 22 is disposed at one side in the first direction than the case 21. The case 22 is connected to one end part of the case 21 in the first direction. The case 23 is disposed at the one side in the first direction than the case 22. The case 23 is connected to one end part of the case 22 in the first direction. The case 24 is disposed at the one side in the first direction than the case 23. The case 24 is connected to one end part of the case 23 in the first direction.

As illustrated in FIGS. 5 and 8, the case 21 includes a plate 21D, a plate 21R, a plate 21B, a plate 21L, and a plate 21F. Each of the plates 21D, 21B, 21R, 21L, and 21F is a plate having a rectangular shape.

The plate 21D extends in the second and third directions described above. The plate 21D has an opening 21H extending through the plate 21D in the first direction.

The plate 21R is disposed at one end part of the plate 21D in the second direction. The plate 21B is disposed at the other end part of the plate 21D in the third direction. The plate 21L is disposed at the other end part of the plate 21D in the second direction. The plates 21R, 21B, and 21L extend from the plate 21D in the first direction.

The plate 21F is disposed on one end part of the plate 21D in the third direction. The plate 21F includes plates 211 through 216. Each of the plates 211 through 216 has a rectangular shape. The plates 211, 213, and 215 extend in the first and second directions. The plates 212, 214, and 216 extend in the first and third directions.

The plate 211 is disposed at the one end part of the plate 21D in the third direction. One end part of the plate 212 in the third direction is connected to one end part of the plate 211 in the second direction. The other end part of the plate 212 in the third direction is connected to one end part of the plate 213 in the second direction. The other end part of the plate 213 in the second direction is connected to one end part of the plate 214 in the third direction. The other end part of the plate 214 in the third direction is connected to the other end part of the plate 215 in the second direction. One end part of the plate 215 in the second direction is connected to the other end part of the plate 216 in the first direction.

The other end part of the plate 216 in the first direction is at the same position as the plate 213 in the first direction.

As illustrated in FIGS. 5, 7, and 9, the case 22 includes a partition plate 22M, a plate 22R, a plate 22B, a plate 22L, and a plate 22F. Each of the partition plate 22M, and the plates 22R, 22B, 22L, and 22R is a plate having a rectangular shape.

The partition plate 22M extends in the second and third directions described above. The partition plate 22M includes an opening 22H, an opening 97, a pillar 98, plates 93 and 94, and a shaft 96.

The position of the opening 22H in the second and third directions is the same as the position of the opening 21H in the second and third directions. The opening 22H extends through the partition plate 22M in the first direction.

The opening 97 extends through the partition plate 22M in the first direction.

The pillar 98, plates 93 and 94, and the shaft 96 extend from the partition plate 22M in the first direction. Within the housing 20, the pillar 98 is positioned at the other side in the second direction than the opening 97.

The plate 93 extends in the third direction. The other end part of the plate 93 in the third direction is connected to the edge of the pillar 98. The other end part of the plate 93 in the third direction is positioned closer to the other end part of the housing 20 in the third direction than the other end part of the plate 93 in the third direction is to the one end part of the housing 20 in the third direction.

The plate 94 extends in the second direction. The plate 94 extends from the one end part of the plate 93 in the third direction. One end part of the plate 94 in the second direction is positioned at one end part of the arm 25 described later in the second direction.

The shaft 96 is inserted into a tape guide 44. The tape guide 44 has a cylindrical shape. The tape guide 44 is rotatable about the shaft 96.

The plate 22R is disposed at one end part of the housing 20 in the second direction. The plate 22R extends in the first and third directions. In the first direction, the partition plate 22M is positioned between one end part and the other end part of the plate 22R in the first direction.

The plate 22B is disposed at the other end part of the housing 20 in the third direction. The plate 22B extends in the first and second directions. In the first direction, the partition plate 22M is positioned between one end part and the other end part of the plate 22B in the first direction.

The plate 22L is disposed at the other end part of the housing 20 in the second direction. The plate 22L extends in the first and third directions. In the first direction, the partition plate 22M is positioned between one end part and the other end part of the plate 22L in the first direction.

The plate 22F is disposed at one end part of the housing 20 in the third direction. The plate 22F includes a plate 221, a plate 223, a plate 224, a plate 225, and a plate 226. Each of the plates 221, 223, 224, 225, and 226 is a plate having a rectangular shape. The plates 221, 223, and 225 extend in the first and second directions. The plates 224 and 226 extend in the first and third directions.

The plate 221 is positioned at one end part of the housing 20 in the third direction. The plate 223 is positioned at the other side in the third direction than the plate 221. The plate 94 is positioned between the plate 221 and the plate 223 in the third direction. Consequently, there is a gap between the plate 221 and the plate 94 in the third direction. Also, there is a gap between the plate 93 and the plate 223 in the third direction.

The other end part of the plate 223 in the second direction is connected to one end part of the plate 224 in the third direction. The other end part of the plate 224 in the third direction is connected to the other end part of the plate 225 in the second direction. Consequently, there is a gap between the plate 93 and the plate 224 in the second direction.

One end part of the plate 225 in the second direction is connected to the other end part of the plate 226 in the third direction. In the third direction, one end part of the plate 226 in the third direction is at the same position as the plate 223.

The arm 25 of the tape cassette 100 is defined by the cases 21 and 22. The arm 25 includes the plates 21F and 22F. Specifically, the arm 25 includes the plate 21D and the plates 211 through 214 of the case 21, and the partition plate 22M and the plates 221, 223 and 224 of the case 22.

The arm 25 has a first discharge port 58, and a second discharge port 59 at the end part of the arm 25. The first discharge port 58 and the second discharge port 59 have slit shapes extending in the first direction. The first discharge port 58 is in communication with the gap between the plate 221 and the plate 94.

The second discharge port 59 is positioned closer to the other end part of the housing 20 in the third direction than the first discharge port 58 is to the other end part of the housing 20 in the third direction. The second discharge port 59 is in communication with the gap between the plate 94 and the plate 223. The discharge port 57 has the first discharge port 58 and the second discharge port 59.

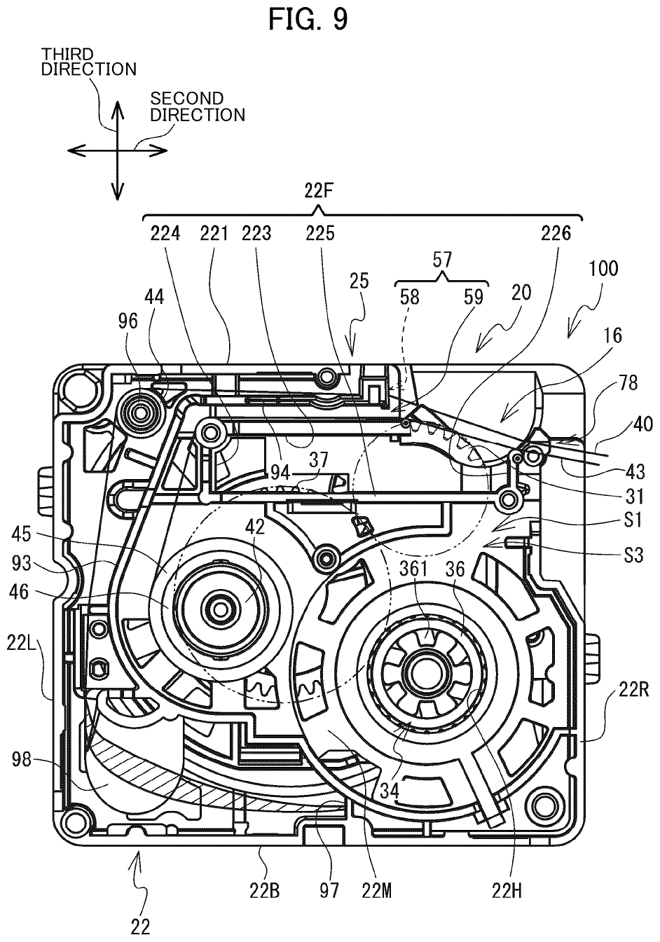

As illustrated in FIG. 9, the housing 20 includes a guide 78. The guide 78 has a slit extending in the first direction. The tape 40 and ink ribbon 43 discharged from the discharge port 57 of the arm 25 is conveyed to the slit of the guide 78. The guide 78 is configured to guide the tape 40 and the ink ribbon 43, which are conveyed through the slit of the guide 78, to the discharge passage 9 of the printer 1. The space positioned at one side in the second direction than the arm 25 is the head opening space.

As illustrated in FIGS. 5, 6, and 10, the case 23 includes a partition plate 23M, a plate 23B, a plate 23R, a plate 23L, and a plate 23F. Each of the partition plate 23M, and the plates 23B, 23R, 23L, and 23F is a plate having a rectangular shape.

The partition plate 23M extends in the second and third directions. The partition plate 23M includes an opening 231, a pillar 232, and a shaft 233.

The opening 231 extends through the partition plate 23M in the first direction. In a state where the case 23 is connected to the case 22, the opening 231 is in communication with the opening 97 illustrated in FIG. 9.

The pillar 232 and the shaft 233 extends from the partition plate 23M in the first direction. The pillar 232 is positioned closer to the one end part of the housing 20 in the second direction than the opening 231 is to the one end part of the housing 20 in the second direction.

The shaft 233 is disposed at the corner of the partition plate 23M. The shaft 233 is positioned at one side in the third direction than the pillar 232. The shaft 233 is inserted into a tape guide 234. The tape guide 234 has a cylindrical shape. The tape guide 234 is rotatable about the shaft 233.

The plate 23R is disposed at one end part of the partition plate 23M in the second direction. The plate 23R extends in the first and third directions. In the first direction, the partition plate 23M is positioned between one end part and the other end part of the plate 23R in the first direction.

The plate 23B is disposed at the other end part of the partition plate 23M in the third direction. The plate 23B extends in the first and second directions. In the first direction, the partition plate 23M is positioned between one end part and the other end part of the plate 23B in the first direction.

The plate 23L is disposed at the other end part of the partition plate 23M in the second direction. The plate 23L extends in the first and third directions. In the first direction, the partition plate 23M is positioned between one end part and the other end part of the plate 23L in the first direction.

The plate 23F is disposed at one end part of the partition plate 23M in the third direction. The plate 23F extends in the first and second directions. In the first direction, the partition plate 23M is positioned between one end part and the other end part of the plate 23F in the first direction.

The housing 20 has an opening 16.

As illustrated in FIG. 5, the case 24 includes a plate 24D, a plate 24R, a plate 24B, a plate 24L, and a plate 24F. Each of the plates 24D, 24R, 24B, 24L, and 24F is a plate having a rectangular shape.

The plate 24D extends in the second and third directions. The plate 24R is positioned at one end part of the plate 24D in the second direction. The plate 24B is positioned at the other end part of the plate 24D in the third direction. The plate 24L is positioned at the other end part of the plate 24D in the second direction. The plate 24F is positioned at one end part of the plate 24D in the third direction. The plates 24R, 24B, 24L, and 24F extend from the plate 24D in the first direction.

The internal space of the housing 20 is partitioned into a first space S1 and a second space S2 by the partition plate 23M. The first space S1 is the space surrounded by the plates 21D, 21F, 21B, 21L, and 21R of the case 21, the plates 22F, 22B, 22L, and 22R of the case 22, and the plates 23F, 23B, 23L, 23R and the partition plate 23M of the case 23. The second space S2 is the space surrounded by the partition plate 23M and the plates 23F, 23B, 23L, 23R of the case 23, and the plates 24D, 24F, 24B, 24L, and 24R of the case 24.

The first space S1 is arranged the second space S2 in the first direction. The arm 25 is positioned closer to the first space S1 than to the second space S2 in the first direction. That is, the arm 25 is positioned on the opposite side of the partition plate 23M from the second space S2 in the first direction. The openings 21H and 22H are in communication with the first space S1.

The first space S1 is partitioned into a third space S3 and a fourth space S4 by the partition plate 22M. The third space S3 is the space surrounded by the plates 21D, 21F, 21B, 21L, and 21R of the case 21, and the partition plate 22M and the plates 22F, 22B, 22L, and 22R of the case 22. The fourth space S4 is the space surrounded by and the plates 22F, 22B, 22L, 22R and the partition plate 22M of the case 22, and the plates 23F, 23B, 23L, 23R and the partition plate 23M of the case 23. The third space S3 and the fourth space S4 are arranged in the first direction.

The tape roll 41 is disposed in the second space S2 of the tape cassette 100. In the second space S2, the tape roll 41 is positioned at the third direction center of the partition plate 23M and at the second direction center of the partition plate 23M.

A holder 49 is fitted to the inside of the tape spool 47. The holder 49 has the rotational axis L49 extending in the first direction. The tape spool 47 is rotatable about the rotational axis L49.

The ribbon roll 45 is disposed in the third space S3 of the tape cassette 100. In the third space S3, the ribbon roll 45 is positioned between the second direction center of the partition plate 22M and the plate 93.

A holder 42 is fitted to the inside of the ribbon spool 46. The holder 42 has the rotational axis L42 extending in the first direction. The ribbon spool 46 is rotatable about the rotational axis L42.

The drive transmission mechanism 30 is disposed in the fourth space S4. The drive transmission mechanism 30 is configured to transmit a drive force transmitted from the transmission gear 679 of the shaft 66E of the drive shaft 63 to the platen roller 82.

The drive transmission mechanism 30 includes the first gear 34, the second gear 31, and a third gear 37. The first gear 34 is rotatable about a rotational axis extending in the first direction. The position of the first gear 34 in the second and third directions is the same as the positions of the openings 21H and 22H in the second and third directions.

The first gear 34 is connected to the second gear 31 via the third gear 37. The first gear 34 is configured to transmit a drive force to the second gear 31. The first gear 34 has a gear 35 and a cam 36. The gear 35 is an external gear which is in meshing engagement with a fourth gear 38 of the third gear 37.

The cam 36 is fixed to the other end part of the gear 35 in the first direction. The cam 36 includes splines 361 on the inner circumferential surface thereof. That is, the cam 36 is a cylindrical internal gear. The cam 36 is exposed to the outside of the housing 20 through the openings 21H and 22H. In other words, the cam 36 is visible from the outside of the housing 20 through the openings 21H and 22H. The shaft 66E of the drive shaft 63 is configured to be inserted into the cam 36 from below.

The second gear 31 is an external gear. The second gear 31 is rotatable about a rotational axis extending in the first direction. The second gear 31 is apart from the first gear 34 in the third direction.

The second gear 31 transmits a drive force to the platen gear 83 for conveying the tape 40 when meshing with the platen gear 83. The second gear 31 is a helical gear. The gear teeth of the second gear 31 are helical at a prescribed angle relative to the first direction. The helical direction of the gear teeth of the second gear 31 is opposite to the helical direction of the gear teeth of the platen gear 83.

Part of the second gear 31 (and specifically, some of the teeth of the second gear 31) is exposed to the outside of the housing 20 through the opening 16. In other words, part of the second gear 31 (and specifically, some of the gear teeth of the second gear 31) is exposed to the space communicating with the head opening space. That is, part of the second gear 31 (and specifically, some of the gear teeth of the second gear 31) is visible from the outside of the housing 20. In a state where the tape cassette 100 is attached to the cassette accommodation section 10, the second gear 31 is in meshing engagement with the platen gear 83 in the space communicating with the head opening space.

The third gear 37 is in meshing engagement with both the first gear 34 and the second gear 31. The third gear 37 is configured to transmit a drive force inputted to the first gear 34 to the second gear 31.

The third gear 37 is a double gear including both the fourth gear 38 and a fifth gear 39 which are positioned coaxially. The diameter of the fifth gear 39 is smaller than the diameter of the fourth gear 38. Furthermore, the fourth gear 38 is disposed further from the tape roll 41 in the first direction than the fifth gear 39 is from the tape roll 41 in the first direction.

The fourth gear 38 is in meshing engagement with the first gear 34. The fourth gear 38 is an external spur gear.

The fifth gear 39 is in meshing engagement with the second gear 31. The fifth gear 39 is an external helical gear. The helical direction of the gear teeth of the fifth gear 39 is opposite to the helical direction of the gear teeth of the second gear 31.

The third gear 37 transmits the drive force inputted into the first gear 34 to the second gear 31 while reducing the rotational speed of the drive force. That is, the drive transmission mechanism 30 also includes a reduction mechanism. In other words, the drive transmission mechanism 30 also functions as a reduction mechanism.

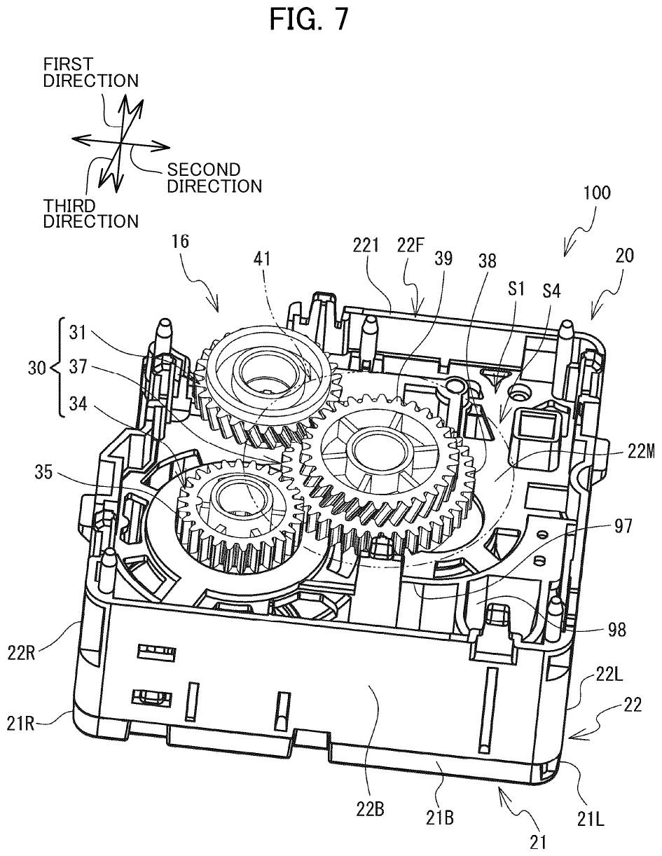

As illustrated in FIGS. 7 and 9 through 11, part of the ribbon roll 45 overlaps part of the tape roll 41 in the first direction (i.e., when viewed in the first direction). Part of the first gear 34 overlaps part of the tape roll 41 in the first direction (i.e., when viewed in the first direction). Part of the second gear 31 overlaps part of the tape roll 41 in the first direction (i.e., when viewed in the first direction). Part of the third gear 37 overlaps part of the tape roll 41 in the first direction (i.e., when viewed in the first direction). Part of the third gear 37 overlaps part of the ribbon spool 46 in the first direction (i.e., when viewed in the first direction).

Printing operations of the printer 1 will be described while referring to FIGS. 9 and 10. The tape cassette 100 is attached to the cassette accommodation section 10 for printing. At this time, the print head 71 is at a position overlapping the tape 40 and ink ribbon 43 in the third direction (i.e., when viewed in the third direction) in the head opening space.

The shaft 66E of the drive shaft 63 is inserted into the first gear 34 positioned in the fourth space S4. The platen roller 82 moves to the adjacent position. Hence, the platen gear 83 comes into meshing engagement with the second gear 31.

In a state where the tape cassette 100 is attached to the cassette accommodation section 10, the shaft 66E of the drive shaft 63 rotates the first gear 34 together with the cam 36. The rotation of the first gear 34 rotates the third gear 37, and hence, the second gear 31 rotates.

The rotation of the second gear 31 rotates the platen gear 83. Consequently, the platen roller 82 rotates.

The rotation of the platen roller 82 draws the tape 40 off the tape roll 41. At the same time, the ink ribbon 43 is drawn off the ribbon roll 45.

The tape 40 is guided to the pillar 232 by the tape guide 234 in the second space S2. The tape 40 is guided to the opening 231 by the pillar 232. The tape 40 is conveyed to the third space S3 through the opening 231 and the opening 97.

The tape 40 is guided to the tape guide 44 by the pillar 98 in the third space S3. In this state, the tape 40 is conveyed in the third direction through the gap between the plate 22L and the plate 93. The tape 40 is guided to the first discharge port 58 by the tape guide 44. In this state, the tape 40 is conveyed in the second direction through the gap between the plate 221 and the plate 94. The tape 40 is discharged to the head opening space through the first discharge port 58.

In the third space S3, the ink ribbon 43 is conveyed toward the one end part of the plate 93 in the third direction. In this state, the ink ribbon 43 is conveyed in the third direction through the gap between the plate 93 and the plate 224. The ink ribbon 43 is guided to the second discharge port 59 by the plate 93. In this state, the ink ribbon 43 is conveyed in the second direction through the gap between the plate 94 and the plate 223. The ink ribbon 43 is discharged to the head opening space through the second discharge port 59.

The tape 40 and the ink ribbon 43, which are discharged from the discharge port 57, overlap each other in the third direction (i.e., when viewed in the third direction). In the head opening space, the tape 40 is pressed by the platen roller 82 against the print head 71 through the ink ribbon 43. The heating elements 71A of the print head 71 are selectively heated. Accordingly, some of the ink provided on the surface of the ink ribbon 43 is transferred onto the tape 40 to print, for example, characters and/or symbols on the tape 40.

The printed tape 40 is guided toward the discharge passage 9 of the printer 1 by the guide 78. Furthermore, the used ink ribbon 43 is conveyed toward the discharge passage 9 of the printer I together with the printed tape 40. In other words, the leading edge of the tape 40 and the leading edge of the ink ribbon 43 discharged from the discharge port 57 are positioned in the outside of the housing 20, without returning to the inside of the housing 20. That is, each of the tape 40 and the ink ribbon 43 has a leading part extending from the inside of the arm 25 to the outside of the housing 20 through the discharge port 57 and the head opening space. Each leading part has the leading edge positioned in the outside of the housing 20.

After printing is completed, the printed tape 40 cut off from the tape 40 and the used ink ribbon 43 cut off from the ink ribbon 43 are separated from the printer 1.

As described above, the tape cassette 100 includes the ribbon roll 45, the tape roll 41, and the housing 20. The housing 20 includes the partition plate 23M and the arm 25. The partition plate 23M partitions the internal space of the housing 20 into the first space S1 and the second space S2. The first space S1 and the second space S2 are arranged in the first direction. In the ribbon roll 45, the ink ribbon 43 is wound. The ribbon roll 45 is positioned in the first space S1. The ribbon roll 45 is rotatable about the rotational axis L42. In the tape roll 41, the tape 40 is wound. The tape roll 41 is positioned in the second space S2. The tape roll 41 is rotatable about the rotational axis L49. The rotational axes L42 and L49 extend in the first direction. The arm 25 is positioned closer to the first space S1 than to the second space S2 in the first direction. That is, the arm 25 is positioned on the opposite side of the partition plate 23M from the second space S2 in the first direction. The arm 25 has the discharge port 57. The discharge port 57 allows the ink ribbon 43 and the tape 40 to be discharged to the head opening space therethrough. The leading edge of the ink ribbon 43 discharged from the discharge port 57 is positioned in the outside of the housing 20. That is, the ink ribbon 43 has the leading part extending from the interior of the arm 25 to the outside of the housing 20 through the discharge port 57 and the head opening space, and the leading part of the ink ribbon 43 has the leading edge positioned in the outside of the housing 20.

In the tape cassette 100 described above, the ink ribbon 43 discharged from the discharge port 57 is used for printing the tape 40. The leading edge of the ink ribbon 43 discharged from the discharge port 57 is positioned at the outside of the housing 20. That is, the ink ribbon 43 has the leading part extending from the interior of the arm 25 to the outside of the housing 20 through the discharge port 57 and the head opening space, and the leading part of the ink ribbon 43 has the leading edge positioned in the outside of the housing 20. Hence, the used ink ribbon 43 does not remain in the inside of the housing 20. With the configuration of the tape cassette 100, the leading edge of the used ink ribbon 43 can be positioned in the outside of the housing 20.

Part of the ribbon roll 45 overlaps part of the tape roll 41 in the first direction (i.e., when viewed in the first direction). Accordingly, the tape cassette 100 can be made smaller in a direction orthogonal to the first direction than a configuration in which part of the ribbon roll 45 does not overlap part of the tape roll 41 in the first direction (i.e., when viewed in the first direction).

The tape cassette 100 includes the partition plate 22M, the first gear 34, and the second gear 31. The partition plate 22M partitions the first space S1 into the third space S3 and the fourth space S4. The ribbon roll 45 is positioned in the third space S3. The first gear 34 and the second gear 31 are positioned in the fourth space S4. Part of the second gear 31 (and specifically, some of the gear teeth of the second gear 31) is exposed from the opening 16 (i.e., part of the second gear 31 is visible from outside the housing 20). Accordingly, a space for accommodating the first gear 34 and the second gear 31 can be secured in the tape cassette 100. Furthermore, since part of the second gear 31 (and specifically, some of the gear teeth of the second gear 31) is exposed from the opening 16 (i.e., part of the second gear 31 is visible from outside the housing 20) in the tape cassette 100, the drive force can be reliably transmitted to the outside of the tape cassette 100.

The housing 20 has the openings 21H and 22H. The openings 21H and 22H are in communication with the first space S1. The first gear 34 includes the cam 36. The cam 36 is exposed to the outside of the housing 20 through the openings 21H and 22H (i.e., the cam 36 is visible from outside the housing 20 through the openings 21H and 22H). With this configuration of the tape cassette 100, the drive shaft 63 can be inserted into the cam 36 through the openings 21H and 22H for driving the cam 36.

Part of the second gear 31 overlaps part of the tape roll 41 in the first direction (i.e., when viewed in the first direction). Accordingly, the tape cassette 100 can be made smaller in a direction orthogonal to the first direction than a configuration in which part of the second gear 31 does not overlap part of the tape roll 41 in the first direction (i.e., when viewed in the first direction).

Part of the first gear 34 overlaps part of the tape roll 41 in the first direction (i.e., when viewed in the first direction). Accordingly, the tape cassette 100 can be made smaller in a direction orthogonal to the first direction than a configuration in which part of the first gear 34 does not overlap part of the tape roll 41 in the first direction (i.e., when viewed in the first direction).

The second gear 31 is a helical gear. When a drive force is transmitted from the second gear 31 to the platen gear 83 mounted on the platen roller 82 of the printer 1, a thrust force is applied to the second gear 31 in a direction in which the tape cassette 100 is pushed into the printer 1. Therefore, the tape cassette 100 can be restricted from moving upward in the printer 1.

The third gear 37 is disposed in the fourth space S4. The third gear 37 is in meshing engagement with both the first gear 34 and the second gear 31. With this configuration of the tape cassette 100, a drive force can be transmitted between the first gear 34 and the second gear 31 via the third gear 37.

Part of the third gear 37 overlaps part of the tape roll 41 in the first direction (i.e., when viewed in the first direction). Accordingly, the tape cassette 100 can be made smaller in a direction orthogonal to the first direction than a configuration in which part of the third gear 37 does not overlap part of the tape roll 41 in the first direction (i.e., when viewed in the first direction).

Part of the third gear 37 overlaps part of the ribbon roll 45 in the first direction (i.e., when viewed in the first direction). Accordingly, the tape cassette 100 can be made smaller in a direction orthogonal to the first direction than a configuration in which part of the third gear 37 does not overlap part of the ribbon roll 45 in the first direction (i.e., when viewed in the first direction).

The third gear 37 is disposed in the fourth space S4. The third gear 37 is a double gear. The third gear 37 includes the fourth gear 38 and the fifth gear 39. The fourth gear 38 is in meshing engagement with the first gear 34. The fifth gear 39 is in meshing engagement with the second gear 31. With this configuration of the tape cassette 100, the drive force can be transmitted between the first gear 34 and the second gear 31 via the double gear.

In the ribbon roll 45, the ink ribbon 43 is wound about the ribbon spool 46. Since the ink ribbon 43 is wound about the ribbon spool 46, the ink ribbon 43 can be stably conveyed in the tape cassette 100.

In the tape roll 41, the tape 40 is wound about the tape spool 47. Since the tape 40 is wound about the tape spool 47, the tape 40 can be stably conveyed in the tape cassette 100.

In the above embodiment, the rotational axis L42 is an example of the “first rotational axis” in the present disclosure. The rotational axis L49 is an example of the “second rotational axis” in the present disclosure. The partition plate 23M is an example of the “first partition plate” in the present disclosure. The partition plate 22M is an example of the “second partition plate” in the present disclosure. The openings 21H and 22H are each an example of the “cam opening” in the present disclosure. The third gear 37 is an example of the “double gear” in the present disclosure. The head opening space is an example of the “opening space” in the present disclosure.

While the invention has been described in conjunction with various example structures outlined above and illustrated in the figures, various alternatives, modifications, variations, improvements, or substantial equivalents, whether known or that may be presently unforeseen, may become apparent to those having at least ordinary skill in the art. Accordingly, the example embodiment of the disclosure, as set forth above, is intended to be illustrative of the invention, and not limiting the invention. Various changes may be made without departing from the spirit and scope of the disclosure. Therefore, the disclosure is intended to embrace all known or later developed alternatives, modifications, variations, improvements, or substantial equivalents.

In the above embodiment, the housing 20 has the configuration illustrated in FIG. 5. However, the shapes of the cases 21, 22, 23, and 24 may be modified as appropriate, for example.

In the above embodiment, the internal space in the housing 20 is partitioned by the partition plate 23M. The position of the partition plate 23M may be modified as appropriate. That is, the size of each first space S1 and second space S2 may be adjusted according to the dimensions of the tape 40 and ink ribbon 43.

In the above embodiment, the drive transmission mechanism 30 includes the first gear 34, the second gear 31, and the third gear 37. However, the third gear 37 may be omitted, for example. In this case, the gear 35 of the first gear 34 directly engages with the second gear 31. The dimensions of the first gear 34, second gear 31, and third gear 37 may also be modified as appropriate.

In the above embodiment, the third gear 37 is a double gear. However, the third gear 37 may be a single gear, for example.

The drive transmission mechanism 30 includes the first gear 34, the third gear 37, and the second gear 31 each of that rotates about a rotational axis extending in the first direction. However, the drive transmission mechanism 30 may be configured to transmit a drive force using spur gears, helical gears, external gears, internal gears, combinations of worm gears and worm wheels, for example. The drive transmission mechanism 30 may also be configured to transmit a drive force using components which are not gears and are configured to rotate about axes. The components are combinations of toothed belts and sprockets, combinations of bevel gears and drive shafts, and rack and pinion mechanisms, for example.

In the above embodiment, the shaft 96 and the tape guide 44 are disposed on the partition plate 22M of the case 22. However, the shaft 96 may be disposed on the plate 21D of the case 21, for example. Also, the shaft 96 may be disposed anywhere within the housing 20, as long as the tape guide 44 is disposed at a position capable of guiding the tape 40 positioned in the third space S3.

In the above embodiment, the tape 40 is wound about the tape spool 47 in the tape roll 41. However, the tape 40 alone (i.e., the tape 40 itself) may be wound into a roll. In other words, the tape spool 47 may be omitted from the tape roll 41.

In the above embodiment, the ink ribbon 43 is wound about the ribbon spool 46 in the ribbon roll 45. However, the ink ribbon 43 alone (i.e., the ink ribbon 43 itself) may be wound into a roll. In other words, the ribbon spool 46 may be omitted from the ribbon roll 45.

In the above embodiment, the partition plate 22M partitions the first space S1 into the third space S3 and the fourth space S4. The position of the partition plate 22M may be modified as appropriate. That is, the size of each third space S3 and fourth space S4 may be adjusted according to the dimensions of the tape 40, and the drive transmission mechanism 30.

The first gear 34 need not include the cam 36, for example. The housing 20 need not have the opening 21H, for example. The housing 20 need not have the opening 22H, for example. The cam 36 need not be exposed to the outside of the housing 20 through the openings 21H and 22H, for example. That is, the cam 36 need not be visible from the outside the housing 20 through the openings 21H and 22H.

The positions of the ribbon roll 45, tape roll 41, and drive transmission mechanism 30 in the second and third directions may be modified as appropriate. Part of the ribbon roll 45 need not overlap part of the tape roll 41 in the first direction (i.e., when viewed in the first direction), for example.

Part of the second gear 31 need not overlap part of the tape roll 41 in the first direction (i.e., when viewed in the first direction), for example. Part of the first gear 34 need not overlap part of the tape roll 41 in the first direction (i.e., when viewed in the first direction), for example. Part of the third gear 37 need not overlap part of the tape roll 41 in the first direction (i.e., when viewed in the first direction), for example. Part of the third gear 37 need not overlap part of the ribbon roll 45 in the first direction (i.e., when viewed in the first direction), for example.

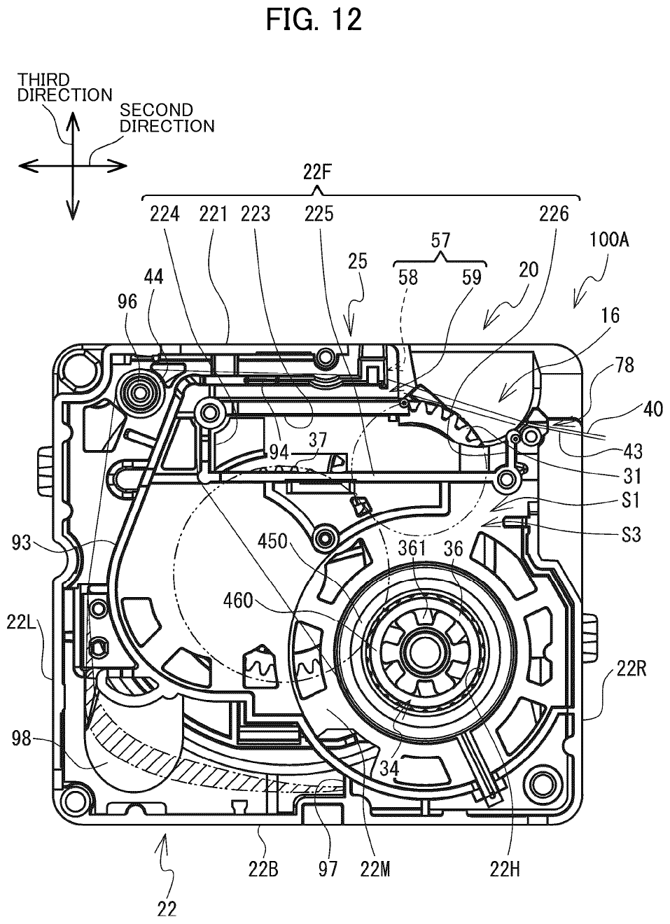

A variation of the present disclosure will be described while referring to FIG. 12. The configuration of a tape cassette 100A is almost the same as the configuration of the tape cassette 100 described in the above embodiment. Accordingly, components identical to the components of the tape cassette 100 in the above embodiment are designated with the same reference numerals. The following description will elaborate on the parts of the tape cassette 100A that are different from the tape cassette 100 in the above embodiment.

The tape cassette 100A in this variation includes a ribbon roll 450 illustrated in FIG. 12 instead of the ribbon roll 45. The configuration of the ribbon roll 450 is identical to the configuration of the ribbon roll 45. The position of the ribbon roll 450 in the third space S3 differs from the position of the ribbon roll 45 in the third space S3.

In the third space S3, the ribbon roll 450 is positioned between the one end part of the partition plate 22M in the second direction and the second direction center of the partition plate 22M. The ribbon roll 450 overlaps the first gear 34 and the third gear 37 in the first direction (i.e., when viewed in the first direction).

When printing is started, the ink ribbon 43 is drawn off the ribbon roll 450 by the platen roller 82 being driven. After that, the ink ribbon 43 is conveyed through the gap between the plate 93 and the plate 224 in the third direction, and the gap between the plate 94 and the plate 223 in the second direction. Then, the ink ribbon 43 is discharged to the outside of the housing 20 through the second discharge port 59 and the head opening space. With this configuration of the tape cassette 100A, the leading edge of the ink ribbon 43 discharged through the discharge port 57 and the head opening space is positioned in the outside of the housing 20. That is, the ink ribbon 43 has the leading part extending from the interior of the arm 25 to the outside of the housing 20 through the discharge port 57 and the head opening space, and the leading part of the ink ribbon 43 has the leading edge positioned in the outside of the housing 20.

As described above, the tape cassette 100A includes the ribbon roll 450. Part of the first gear 34 overlaps part of the ribbon roll 450 in the first direction (i.e., when viewed in the first direction). Accordingly, the tape cassette 100A can be made smaller in a direction orthogonal to the first direction than a configuration in which part of the first gear 34 does not overlap part of the ribbon roll 450 in the first direction (i.e., when viewed in the first direction).

What is claimed is:

1. A tape cassette comprising:
a ribbon roll in which an ink ribbon is wound, the ribbon roll being rotatable about a first rotational axis extending in a first direction;
a tape roll in which a tape is wound, the tape roll being rotatable about a second rotational axis extending in the first direction; and
a housing having an opening space in which the tape and the ink ribbon overlap each other for printing, the housing including:
a first partition plate partitioning an internal space of the housing into a first space in which the ribbon roll is positioned and a second space in which the tape roll is positioned, the first space and the second space being arranged in the first direction; and
an arm positioned on an opposite side of the first partition plate from the second space in the first direction, the arm having a discharge port allowing the ink ribbon and the tape to be discharged to the opening space through the discharge port;
wherein the ink ribbon has a leading part extending from an interior of the arm to an outside of the housing through both the discharge port and the opening space, the leading part having a leading edge positioned outside the housing.

2. The tape cassette according to claim 1,
wherein the ribbon roll overlaps the tape roll in the first direction.

3. The tape cassette according to claim 1, further comprising:
a first gear; and
a second gear configured to be operated by an operation of the first gear,
wherein the housing further includes:
a second partition plate partitioning the first space into a third space in which the ribbon roll is positioned and a fourth space in which the first gear and the second gear are positioned, the third space and the fourth space being arranged in the first direction, and
wherein a part of the second gear is visible from the outside of the housing.

4. The tape cassette according to claim 3,
wherein the housing has a cam opening in communication with the first space,
wherein the first gear includes a cam, and
wherein the cam is visible through the cam opening from the outside of the housing.

5. The tape cassette according to claim 3,
wherein a part of the second gear overlaps a part of the tape roll in the first direction.

6. The tape cassette according to claim 3,
wherein a part of the first gear overlaps a part of the tape roll in the first direction.

7. The tape cassette according to claim 3,
wherein a part of the first gear overlaps a part of the ribbon roll in the first direction.

8. The tape cassette according to claim 3,
wherein the second gear is a helical gear.

9. The tape cassette according to claim 3, further comprising:
a third gear positioned in the fourth space, the third gear being in meshing engagement with both the first gear and the second gear.

10. The tape cassette according to claim 9,
wherein a part of the third gear overlaps a part of the tape roll in the first direction.

11. The tape cassette according to claim 9,
wherein a part of the third gear overlaps a part of the ribbon roll in the first direction.

12. The tape cassette according to claim 3, further comprising:
a double gear positioned in the fourth space, the double gear including:
a third gear in meshing engagement with the first gear; and
a fourth gear in meshing engagement with the second gear.

13. The tape cassette according to claim 12,
wherein a part of the double gear overlaps a part of the tape roll in the first direction.

14. The tape cassette according to claim 12,
wherein a part of the double gear overlaps a part of the ribbon roll in the first direction.

15. The tape cassette according to claim 1,
wherein, in the ribbon roll, the ink ribbon is wound around a ribbon spool extending in the first direction.

16. The tape cassette according to claim 1,
wherein, in the tape roll, the tape is wound around a tape spool extending in the first direction.
